(19) United States
(12) Patent Application Publication
(10) Pub. No.: US 2002/0049750 A1
(43) Pub. Date: Apr. 25, 2002

(54) Concept mapping based knowledge acquisition system and methods

(76) Inventor: Srinivas Venkatram, Mumbai (IN)

Correspondence Address: Rashida A. Karmali, Suite 2525, 230 Park Avenue, New York, NY, 10169, US

(21) Appl. No.: 09/829,153

(22) Filed: Apr. 9, 2001

Related U.S. Application Data
(63) Continuation-in-part of application No. 09/546,704, filed on Apr. 10, 2000.

(51) Int. Cl. G06F 7/00

(52) U.S. Cl. 707/3

(57) ABSTRACT

An interlocking artificial intelligence system and methods including the present invention comprises a system and methods including, but not limited to: a) a presentation layer which attempts to contextualise the use of a database for a specific seeker of information and related to a specific activity, decision, context or situation, b) a mapping engine which carries out the primary tasks of linking up the seeker-context to the appropriate documents and search results from the database, and c) a database which comprises of numerous documents which include, but are not limited to all types of media such as paper or film and/or from numerous sources. The frameworks of concepts or objects can be updated routinely and the programs adapted to provide a knowledge-based system to build competency in diverse specialties including education, commerce, financing, e-commerce, health care, agriculture, real estate, navigation, traveling or industry operations in general.

### CROSS-REFERENCE TO RELATED APPLICATIONS

This Application is a Continuation-In-Part of co-pending U.S. Patent Application Ser. No. 09/546,704, the entire disclosure of which is incorporated herein by reference.

### FIELD OF THE INVENTION

The present invention comprises a system and methods including, but not limited to: a) a presentation layer which attempts to contextualise the use of a database for a specific seeker of information and related to a specific activity, decision, context or situation, b) a mapping engine which carries out the primary tasks of linking up the seeker-context to the appropriate documents and search results from the database, and c) a database which comprises of numerous documents which include, but are not limited to all types of media such as paper or film and/or from numerous sources.

The present invention relates to an artificial intelligence software system comprising a framework of concepts or objects of knowledge for competency testing and building, and more particularly to a specialty or subject-based knowledge source process for such a system. This invention relates to concept or object management in database systems for storing and manipulating any kind of data on internet. The internet is a huge database storing different types of data through the creation of a large number of different concepts or objects e.g. text, file, audio, video, multimedia, image or E-mail. Evaluating such a large database from many different perspectives to build competency in a specific field demands new technological solutions. The frameworks of concepts or objects can be updated routinely and the programs adapted to provide a knowledge-based system to build competency in diverse specialties including education, commerce, financing, e-commerce, health care, agriculture, real estate, navigation, traveling or industry operations in general.

### BACKGROUND OF THE INVENTION

The process of organizing and deferring knowledge is usually defined by the medium of communication. Knowledge in books, for example, is represented in the form of pages and chapters, etc. On the other hand, films are generally organized around scenes and frames. In general, when a new medium of communication is created, the first group of users and creators in that medium will use the “knowledge structure” of an earlier medium with some variations. It is only after some familiarity with the new medium has developed that a more appropriate “knowledge structure” emerges that allows the medium to be fully exploited and used effectively.

The same process has been at work in the creation, storage, and dissemination of information through the medium of the computer. In the first 25 years of computers, designers utilized the hierarchical structure of print media: pages, words and paragraphs within pages, pages organized into chapters, and so forth. This approach defined both the designs of packages like Microsoft Word and the logic for organizing large quantities of information within industry and government.

It must be noted that during this period, alternate structures have evolved for specific categories of information, such as, for example, numerical databases and spreadsheets. Once developed, these structures have become widely prevalent and widely used. There have been, however, almost no significant developments or changes in the way “written matter” has been organized until the beginning of the past decade. “Written matter,” which ranges from documents of various kinds to individual notes, continues to be organized as pages and files stored and retrieved hierarchically. FIG. 1. Such written matter includes both explicit knowledge, such as published or formally drafted works, and knowledge acquired in the course of work or interaction, referred to as tacit knowledge.

The development of hyper-text and the Internet has given creators of knowledge the possibility of breaking free from the hierarchical structures inherited from print media. These hierarchical structures do not allow cross-database navigation and are poor learning tools. Hyper-textual structures, on the other hand, have made it possible to organize knowledge as a series of “linked” pages. This permits easy navigation through the pages, but results in information overload. In addition, this physical form, of linking pages has actually resulted in an interim period of confusion, in which web-sites' organization ranges from purely hierarchical structures to the other extreme of random collections of linked pages. As a result, there are wide variations in the organization and structure of web sites and a consequent inability on the part of most users to correctly anticipate and evaluate the real utility of most information experiences on the Internet.

This confusion has also resulted in the widespread dependence on and use of various types of search engines, which attempt to enable users to actually get the information they want from the numerous web-sites and thousands of web pages.

This confusion also accounts for one of the most important problems faced by business today: namely, the problem of capturing, appropriately storing, and retrieving the numerous form of tacit and explicit knowledge that are generated in the course of work.

Hypertext and the Internet has also had an important impact on the education sector. Since these new media have continued to use old knowledge structures, they have been perceived primarily as technological innovations without an impact on the process of learning or knowledge assimilation. The real impact is perceived to be better communication through, for example, multimedia packages, and from access to large amounts of information. In general, knowledge is part of a continuum that knowledge management practitioners usually depict as a pyramid. Data, the largest component, forms the base, information is the middle level, and knowledge is at the top. In other words, think of data as raw numbers and text gathered and put in context in an electronic system, an accounting spreadsheet or on pages of a magazine. Knowledge adds even more value, containing the expressly human contributions of synthesis and experience. Some theorists talk of “wisdom” as a fourth level of corporate knowledge. It is hard to define, but it includes the ability to tell what is true and sensible and the ability to understand knowledge and gain useful insights for acting upon it.

Thus, corporate knowledge reveals not just what an organization does—whether it manufactures widgets, manages money or offers professional services—but also how it goes about its business and why it does what it does. Therefore, knowledge is not confined to systems and documents but exists in the company culture and the minds and interactions of its people. What employees do—and how they do it—also constitutes knowledge, whether they work on a loading dock or in an executive suite.

Thus, the central question that needs to be addressed is: What is the most appropriate unit of analysis for organizing knowledge in a networked medium? By point of comparison, the appropriate unit for print media is the page, the unit for film media is the scene, and the unit for databases is the record. This question can be answered simply if knowledge is visualized as a framework of concepts, or more appropriately, as an interlocked universe of frameworks, each linking a set of concepts in a unique manner. Thus, this interlocking artificial intelligence system comprising a database organized into frameworks of concepts or objects, leads to a new set of paradigms about how knowledge is understood, organized, presented and assimilated. More particularly, when this artificial intelligence system is applied to specific fields or situations, it enables knowledge that has been filtered through the huge Internet database, to be applied to specific cases, thereby raising the competency of solving complex problems and finding optimal solutions.

### SUMMARY OF THE INVENTION

The present invention comprises a system and methods including, but not limited to: a) a presentation layer which attempts to contextualise the use of a database for a specific seeker of information and related to a specific activity, decision, context or situation, b) a mapping engine which carries out the primary tasks of linking up the seeker-context to the appropriate documents and search results from the database, and c) a database which comprises of numerous documents which include, but are not limited to all types of media such as paper or film and/or from numerous sources.

Each element within the database may be tagged in a specific manner in order to allow the appropriate searches to be carried out.

To accomplish the foregoing and other objects, features and advantages of the invention, there is provided an interlocking artificial intelligence system for competency building .n a specific subject or specialty, which includes a knowledge room comprising a database organized into frameworks of concepts or objects representing knowledge retrieved on a specific subject or specialty, and a learning or working room wherein the system organizes, processes, evaluates and applies the assimilated knowledge to specific problems. In other words, it provides the “wisdom” for an organization on why it does its business and how it goes about its business.

In one embodiment, the / [symbol] counseling engine is described which provides a new and more efficient method of searching or retrieving information. The [symbol] counseling engine is a framework of æ concepts, which represent data, which have been refined and reorganized from existing information on the web. The present invention presents these diverse sources of information in relation to individual objects or concepts. [symbol] counseling engines and methods in the form of Electronic Structure Competency Training (ESCOT) packages for personal and business application logic on a specific topic or field can be defined using user-defined types regardless of the location of the object/concept execution on the web. At present, there are a number of portals, which are either organized by specific subjects or topics (e.g. employment, universities, hospitals, banks, auto sales, etc.) or by community categories (e.g. engineers, doctors, architects, etc.). Thus, web-users who search for information on health maintenance, have to search out numerous portals, and very often, after much effort, may find their requirements only partly met. Moreover, the wide variation in both quantity and quality of contact in the various web sites actually create confusion rather than provide reliable guidance. The [symbol] counseling engine of the present invention allows users to make a series of choices on the basis of frameworks and reflexively or intuitively navigate the user to the right entry point into the world of information organized into concepts. Thus, the present invention provides an [symbol] counseling engine that is more effective at providing interlocked artificial intelligence compared to searching by using search directories (Yahoo) and search engines (Altavista). In other words, the present invention uses ESCOT and enables the development of additional navigational portals to meet the user's needs.

A novel feature in ESCOT is the notion of “relational taxonomy”. “Taxonomy” as used herein represents a description of a subject matter. Taxonomies may be based on hierarchies and concepts, among others. Knowledge may be described in terms of concepts. These concepts in an of themselves are not fixed terms. They are variables and are determined by the user of knowledge. In other words, knowledge is subjective and not objective.

The present invention describes a method to establish these concepts. The variable concepts are determined on the basis of the “need to know” associated with work people to. That is, the same concept may mean different sets of knowledge depending upon who is using it and for what purpose. The present invention includes an embodiment to illustrating this point involves a group of knowledge users or seekers. It displays various “activity flows” that describe the work of seekers and become the basis for determining the concepts associated with a seeker context situation; and executed in a particular manner.

The present embodiment also describes a method of representing knowledge in the form of concepts and multiple knowledge paths; in which each knowledge path represents one type of knowledge and comprises of numerous documents.

In the present invention, ESCOT has also been designed for the purpose of competence building. The process of competence building in this invention comprises of diagnosing, accessing learning content, assessing and using work related knowledge and knowledge which is represented in the form of a step graph.

The present invention also provides a process using ESCOT, of testing which process uses a novel approach called concept strength analysis. This is specific to each employee and that employee's role within the corporation, organization or company.

In another embodiment the interlocked artificial intelligence model of concept testing involves mapping out competency criteria for a specific professional or business, linking up each critical unit of work to a corresponding set of units of need to know or necessary qualifications, and building a test module capable of accessing competency levels for each unit of work individually. A critical problem that is encountered in identifying competency gaps of knowledge by workers and more professionally qualified individuals (e.g. finance managers, accountants or advertising agents) is the difficulty involved in (a) correctly identifying the criteria to be tested, (b) linking up tests to specific “knowledge requirements” for a specific job or object profile and (c) identifying any redressable gaps in knowledge. Currently, these competency evaluations are done by relying largely on surrogate parameters such as past experience, job profile or personal assessments. Thus, the concept testing method for competency testing of the present invention provides a reproducible and specific method, which allows objective testing of a worker's competence, as defined by the job description requirements.

In another embodiment, the interlocked artificial intelligence system provides an off-line concept training, which involves creation of structured classroom material, which focuses entirely on a framework of ideas with little emphasis on the data itself. The system focuses on facilitating the acquisition of each of the insights in the framework of ideas. This enables the teacher or -trainer to manage and enable the learning process rather than focus on explaining and teaching the ideas. The delivery of minimum standards for teaching/training of teachers in different locations is an important issue in any education system. When large quantities of information are disseminated to students, it is important for teachers to ensure that the students understand a particular subject or body of knowledge beyond merely memorizing the information and retain at the very least, a minimum level of understanding and knowledge of a particular subject. Concept training begins with the assumption that each training session and the training modules involved represent frameworks of knowledge, which are constructed through inter-relationships of concept units. Concept training further assumes that while information might enable a person to better understand an idea, the acquisition of the idea by a learner is an “insight” process. The critical function of a classroom experience and the role of related reading or study material is generally defined as enabling or facilitating the acquisition of “insight” by the learner. Concept training demonstrates the role of these “insights” in the development of a knowledge structure for that subject or topic.

In another embodiment, an on-line concept training system built on the same assumptions and structure as the off-line training system above, is provided. The on-line concept training further achieves the effect of enabling mastery of a concept through the device of “multiple learning paths.” Methods of learning may vary depending on the person or learner, the subject, the amount of time available, the current priority or familiarity with the process. Thus, the on-line training package of the present invention provides “multiple learning paths” including, but not limited to, on-line case studies, programmed learning sequences, discussion rooms, on-line books and documents and research papers, suited for the different learning needs. In other words, the effective use of tested and proven learning paths sharply reduces the cost of development of on-line learning materials while improving their effectiveness.

In yet another embodiment, a distance concept learning system is provided. This modular format encompasses the off-line distance learning material, the on-line training material and the on-line and off-line student-teacher interaction system built on the above concept learning features. The traditional knowledge domain is recast into a large number of concepts, assessed through the mechanism of different frameworks, user groups and modular study materials that are linked to a particular concept for a specific subject or topic.

### BRIEF DESCRIPTION OF THE DRAWINGS

FIG. 1 describes the existing knowledge structures which include hierarchical studies and hypertexual structures.

FIG. 2 represents a schematic diagram of the knowledge acquisition system. The presentation layer enables the user of the system to define the knowledge seeking context. The mapping engine (i) generates an approximate set of maps that are relevant to the seeker context, (ii) enables the seeker to quickly narrow down the requirements to the level of a concept and knowledge path, and (iii) generate a search query on the basis of this definition. The knowledge base comprises of a numerous individual documents which are linked to related database containing a characterization table each characterization table comprises, of numerous <seeker, context, concept, knowledge path> characterizations.

FIG. 3 represents the presentation layer for knowledge acquisition system related to competency building. Example 1 describes the Learninq Centre Enterprise Portal. Example 2 describes the User-defined Web-site, which includes (1) defining the context and (2) defining the user.

FIG. 4 describes the Map Cluster for Specific Seeker Context.

FIG. 5 describes the (a) Map Structure of Common Navigational Interfaces and (b) Map Structure inherent in the mapping engine defined in the system.

FIG. 6 describes a presentation layer of ESCOT and its link to context model for competency building. A: Context Model for Competency Building; B: Presentation Layer of ESCOT.

FIG. 7 describes the Listing of Activity Profiles associated with finance function in business organization.

FIG. 8 describes the ES COT model in which each Activity map (relevant to one activity profile) leads to numerous concept maps.

FIG. 9 describes the ESCOT model in which each concept Map Leads to a set of Concepts. Each concept is associated with a specific management task.

FIG. 10 describes the concepts and knowledge paths associated with them.

FIG. 11 describes the real cost of information in action.

FIG. 12 describes in the ESCOT model the basis of competency and a flow chart for traditional knowledge and a real work window is presented.

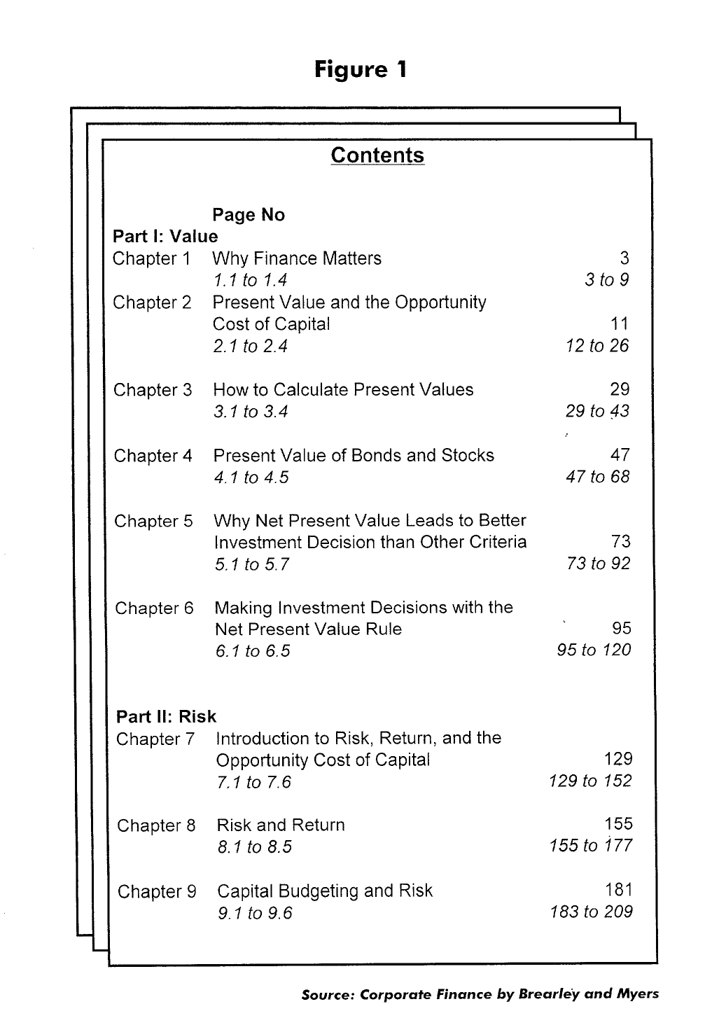

### DESCRIPTION OF THE PREFERRED EMBODIMENT

The present invention comprises a system and methods including, but not limited to: a) a presentation layer which attempts to contextualise the use of a database for a specific seeker of information and related to a specific activity, decision, context or situation, b) a mapping engine which carries out the primary tasks of linking up the seeker-context to the appropriate documents and search results from the database, and c) a database which comprises of numerous documents which include, but are not limited to all types of media such as paper or film and/or from numerous sources.

Each element or document within the database may be tagged in a specific manner in order to allow the appropriate searches to be carried out.

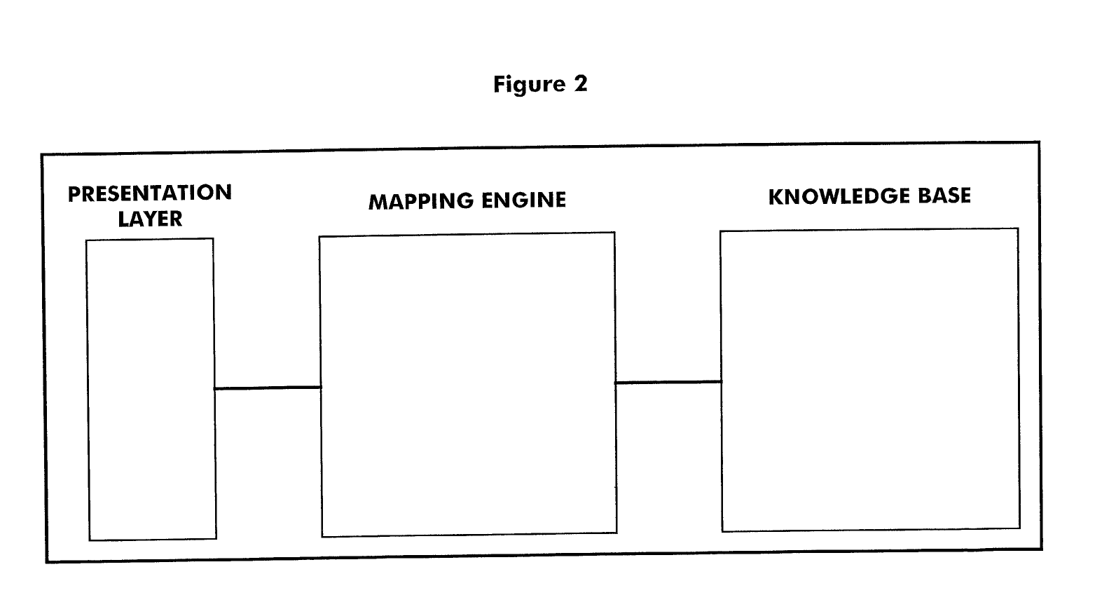

FIG. 2 represents a schematic diagram of the knowledge acquisition system. The presentation layer enables the user of the system to define the knowledge seeking context. The mapping engine (i) generates an approximate set of maps that are relevant to the seeker context, (ii) enables the seeker to quickly narrow down the requirements to the level of a concept and knowledge path, and (iii) generate a search query on the basis of this definition. The knowledge base comprises of a numerous individual documents which are linked to related database containing a characterization table each characterization table comprises, of numerous <seeker, context, concept, knowledge path >characterizations.

### a) The Presentation Layer

It is proposed that the presentation layer establish the identity of the specific seeker of information, the activity or decision in a situation in which the information is being sought and to act as a user-interface, which converts selected commands into computer language, which is understood by the mapping engine.

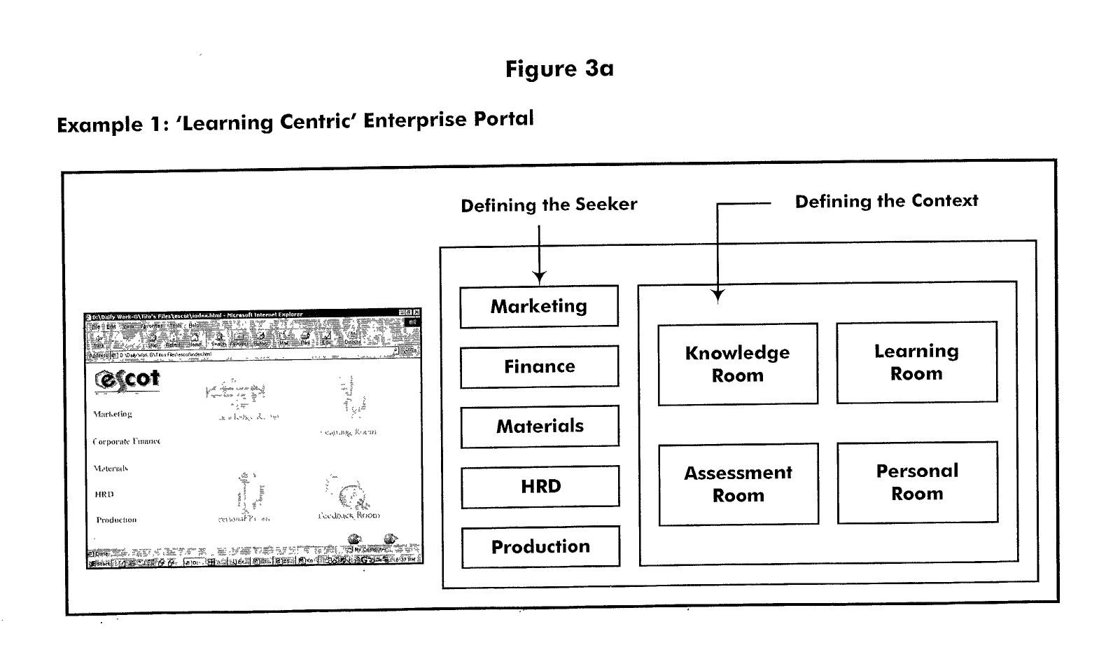

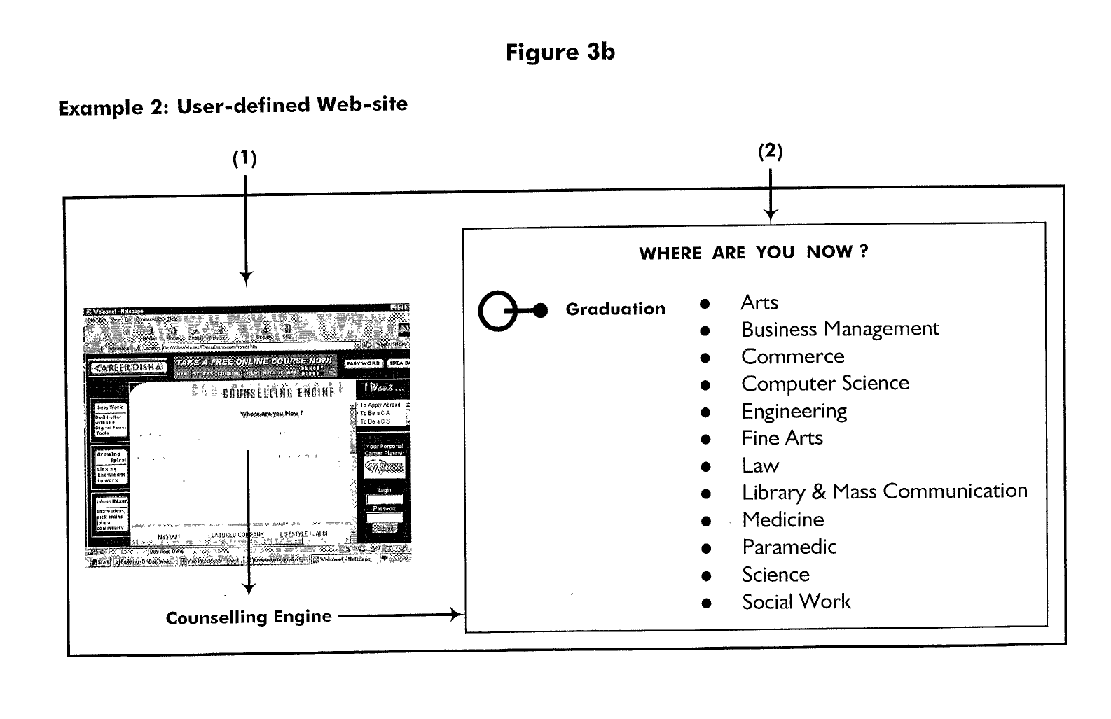

The term “seeker-context” as used herein may be defined in different ways. FIG. 3, Example 1, represents a presentation layer in which the “seeker-context” is defined as the “Finance executive” The Finance executive seeks to develop his or her competency in an appropriate field of activity. Hence the user interface correlates with a unique mode of competency building being suggested to such organizations.

FIG. 3, Example 2 represents the presentation layer for a website which is intended to be a career portal. Hence, the presentation layer is confined to a single page and asks the seeker to identify himself or herself since the context (e.g., career enhancement) is already defined.

### b) The Mapping Engine

The mapping engine comprises of numerous clusters of interlinked maps. The primary purpose of these maps is to link a specific seeker context (as specified in the presentation layer) to the underlying structure of knowledge related to the seeker context (comprising of numerous concepts and knowledge paths, which are uniquely defined.

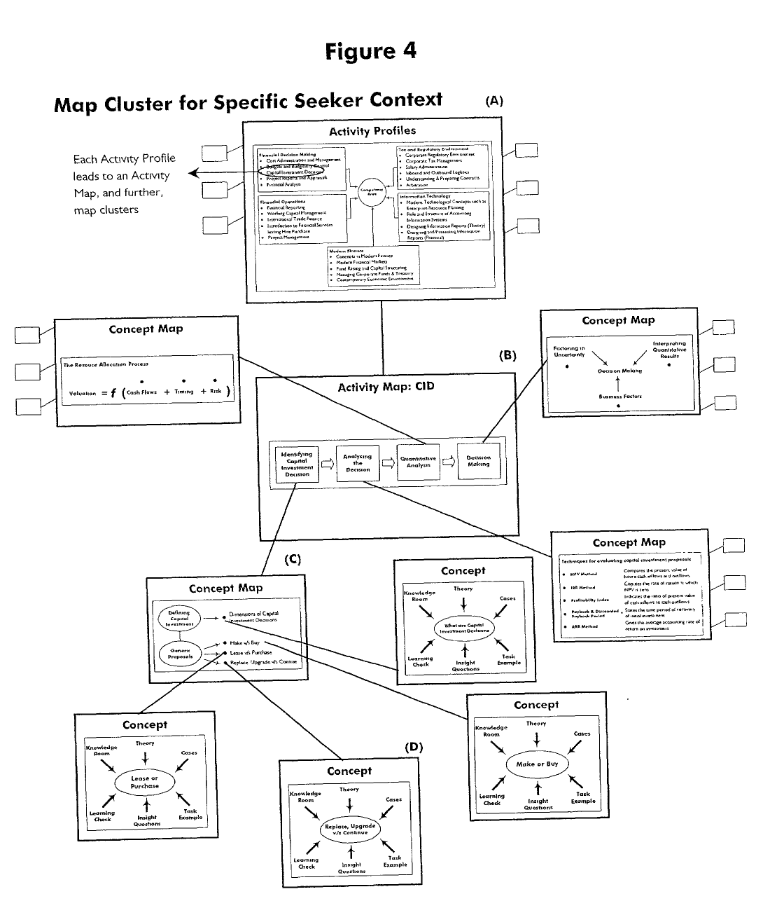

FIG. 4 represents a map cluster for a specific seeker context. The user of the knowledge access system has in the presentation layer, chosen or defined, the seeker context. Thus, the mapping engine shows the user only the appropriate set of maps related to that context. The user navigates through these maps through hypertext links, thereby making numerous additional choices and filtering the decisions therefrom. Under all circumstances the user finally arrives at a “concept page”.

The “concept page” comprises of a single “concept” (which usually is extremely well defined in its scope and purpose) and also contains numerous knowledge paths linked to that concept (with each knowledge path representing one class of documents: a class being defined as documents, either similar in source or medium or any other parameter). This is represented in FIG. 4(D).

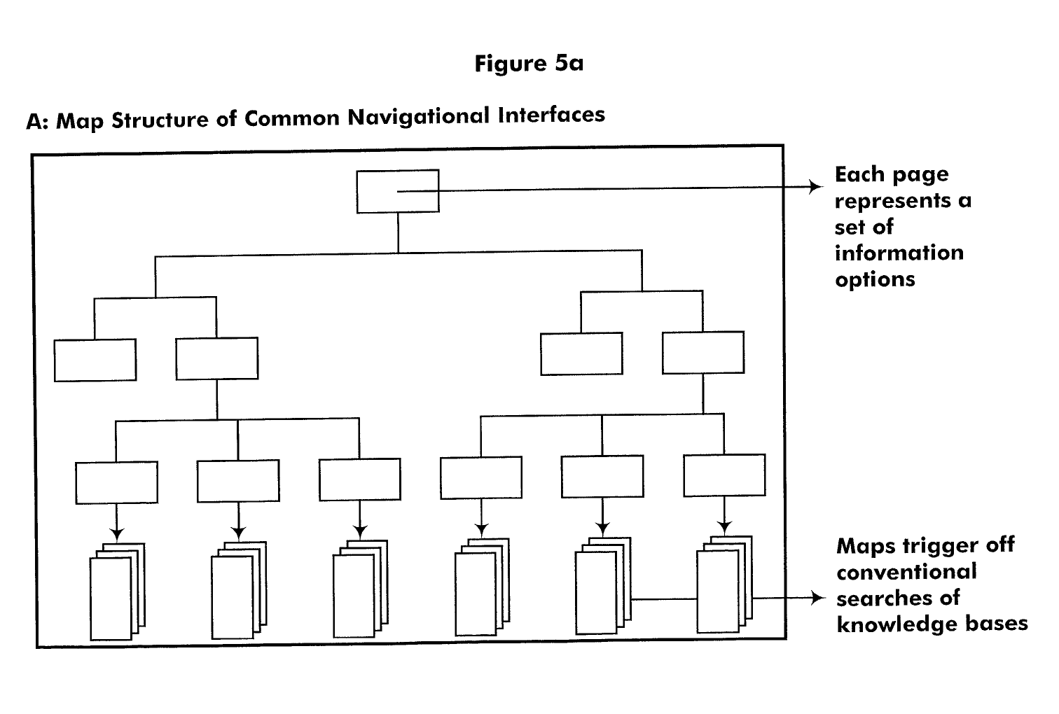

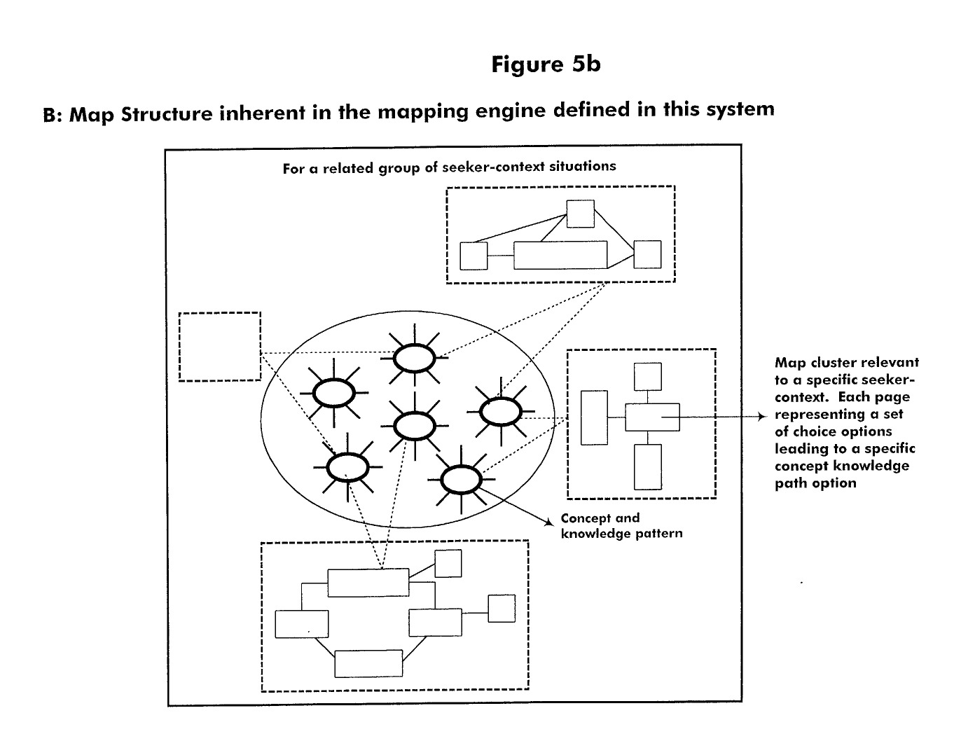

On reaching the “concept page” the user selects, usually through a link or a pull-down menu, any one “knowledge path”. This action triggers off a query of the database. The mapping engine and its underlying knowledge structure are compared and contrasted with conventional navigational maps in FIG. 5, which describes the map structure of common navigational interfaces and the map structure inherent in the mapping engine defined in this system.

### The Knowledgebase

The knowledgebase comprises of numerous documents which include, but are not limited to, web-pages, film-audio archives, or reports from databases. The knowledgebase may be a closed system related to a particular organization or an extremely large collection of documents in an open environment like the Internet.

Each document may be characterized for various combinations of <seeker,; context, concept, knowledge path>. It is obvious that the same document may perform different informational roles in different situations and must therefore be accessed and used differently by different seekers of information in different contexts.

There are numerous database technologies which allow this characterization in different ways. Some prominent technologies would include IBM Lotus Notes, XML, artificial intelligence languages such as Prolog, etc.

For the purpose of this system, the characterization may be schematically represented as in Table 1, which is a representation of knowledge characterization table for a document in knowledge base. This is viewed as being in addition to traditional characterization/meta tagging approaches.

TABLE 1
Document Title:
Knowledge Characterisation Table
<Seeker 1, Context 1, Concept 1, Knowledge Path 1>
<Seeker 2, Context 3, Concept 1, Knowledge Path 7>
<Seeker 30, Context 4, Concept 45, Knowledge Path 1>
<Seeker 11, Context 23, Concept 30, Knowledge Path 5>
<Seeker 29, Context 9, Concept 1, Knowledge Path 100>

The query generated by the mapping engine enables the identification of all documents which meet the <seeker, context, concept, knowledgepath> requirements generated by the mapping engine.

These documents are then displayed by the system through the presentation layer.

it is proposed that the appropriate unit of knowledge in a networked medium is a concept. To elaborate, a concept is defined as a key idea or insight which together with other concepts can be formulated into a framework. For example, valuation is a function of cash flows, timing, and risk. In this framework, valuation, cash flows, timing and risk each represent concepts. Similarly, it is possible to represent a process such as capital investment decisions with a work map that describes the process of capital investment decision making in a business. Each unit of this work map is defined as a concept.

Knowledge has a fractal-like structure. One can go as deep as one wishes into a single concept and generate or assimilate a whole new set of frameworks and concepts, or one can telescope an entire set of frameworks into a single concept within a framework more applicable to one's area of work. The word ‘cash flow’ would be a concept in some situations, a mere word to a novice in the field, and an entire set of frameworks to a person specializing in the field.

Concept is a highly personal formulation varying from individual to individual. In practice, however, each group of professionals engaged in a common area of practice would have a common set of frameworks and consequently a collection of concepts which would have a unique meaning for that group. These concepts and frameworks are the more natural and appropriate means of organizing and presenting information and tacit/explicit knowledge than pages and words. The collection of concepts used by individuals working in a similar or single institutional setting can be represented by an organizational work map, by academics and researchers engaged in exploring a common body of knowledge by a subject area work map, and by a community of individuals sharing common interests by an interest map.

Concepts are also entry points into the information stored in the numerous databases and web-sites all over the world. Information can now be retrieved on the basis of framework, concept, or lists of concepts referred to as knowledge paths. The framework defines the context based on the activity and the users involved. The concept then defines the specific topic or unit of work within the context. This permits one to define the purpose or end goal of the information search. This search mechanism allows users to start by defining themselves and their work and through that, their information need. These definitions act as a search mechanism and retrieves or sets up access to relevant databases. At the next stage of the search, users define their purpose to filter out access precisely those information sources from multiple sources that are necessary to accomplish their current task.

Thus, this conceptualization leads to a new set of paradigms about how knowledge is to be understood, organized, presented, and assimilated. Equally important, when applied in specific situations, it leads to extremely elegant and simple solutions to otherwise vexing problems.

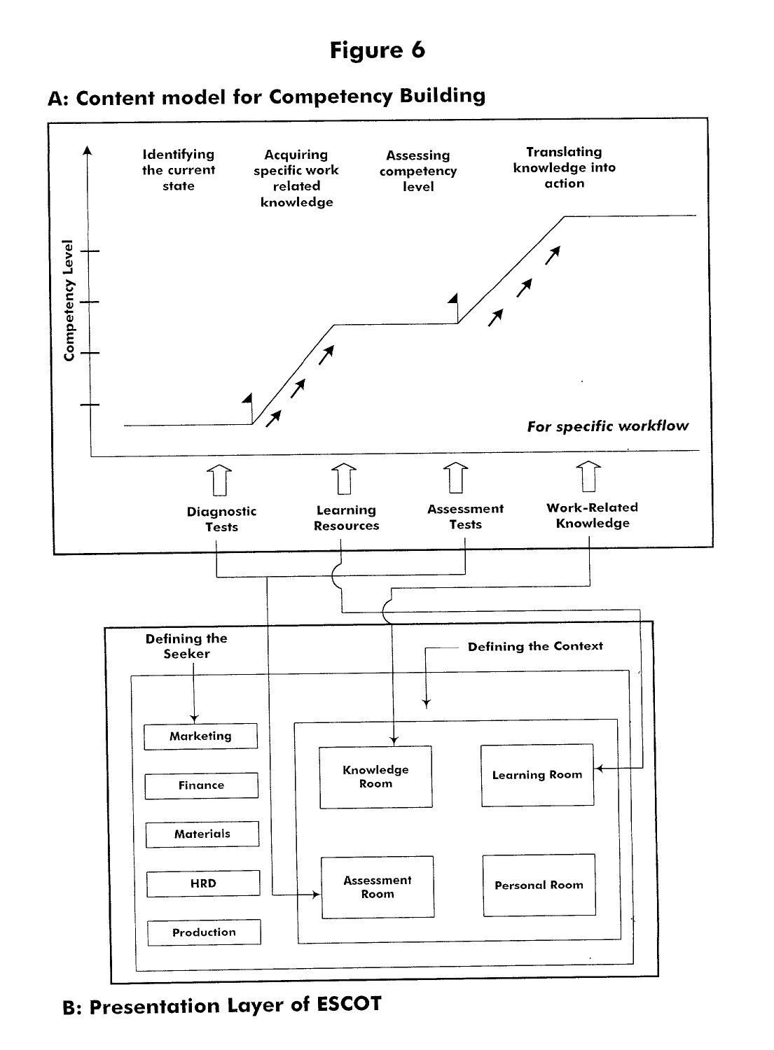

The present invention will be explained in detail by way of a preferred embodiment thereof in conjunction with accompanying drawings herewith. Referring first to FIG. 6, there is shown an on-line ESCOT training package comprising multiple learning paths.

### ESCOT SYSTEM—A PREFERRED EMBODIMENT OF THE INVENTION

### Establishing the Seeker Context

One embodiment of the concept mapping based knowledge acquisition system comprises of the ESCOT System (Electronic Structured Competency Training Platform). This system is intended for the specific seeker group of corporate managers and executives. The context is the widely perceived need felt by corporate managers to continuously enhance (a) their conceptual clarity of various managerial tasks and decision making situations at the time when they need it (b) their ability to enhance their work performance by obtaining knowledge captured within the organization while they are performing a specific set of tasks.

This context is captured in a unique process of competency building. The process allows a corporate executive to (a) diagnose gaps in one's conceptual understanding of the work profile (b) access and acquire specific learning inputs as related to the identified gaps in understanding/knowledge of the manager's work profile (c) establish that one has achieved benchmarked level of conceptual charity needed to perform the set of tasks and decision making in that work profile (a) translate the superior conceptual understanding into enhanced work productivity by acquiring work specific knowledge resources from across the corporate organization and external informational sources.

FIG. 6 describes the presentation layer of ESCOT and its link to context model for competency building.

### Presentation Layer of ESCOT

The presentation layer of ESCOT enables the corporate manager to establish the seeker context. In this case, seekers are defined as various functional or task groups in organizations, including but not limited to a finance function or marketing function. This is further modified by industry (insurance healthcare, etc.) or by different business units in an organization (operations, MIS, customer care, etc.) The context is defined by the type of competency building input needed (diagnosing of conceptual gaps, acquiring specific learning inputs, etc.) FIG. 6A describes the context model for competency building. FIG. 6B describes the presentation layer of ESCOT.

### Mapping Engine of ESCOT

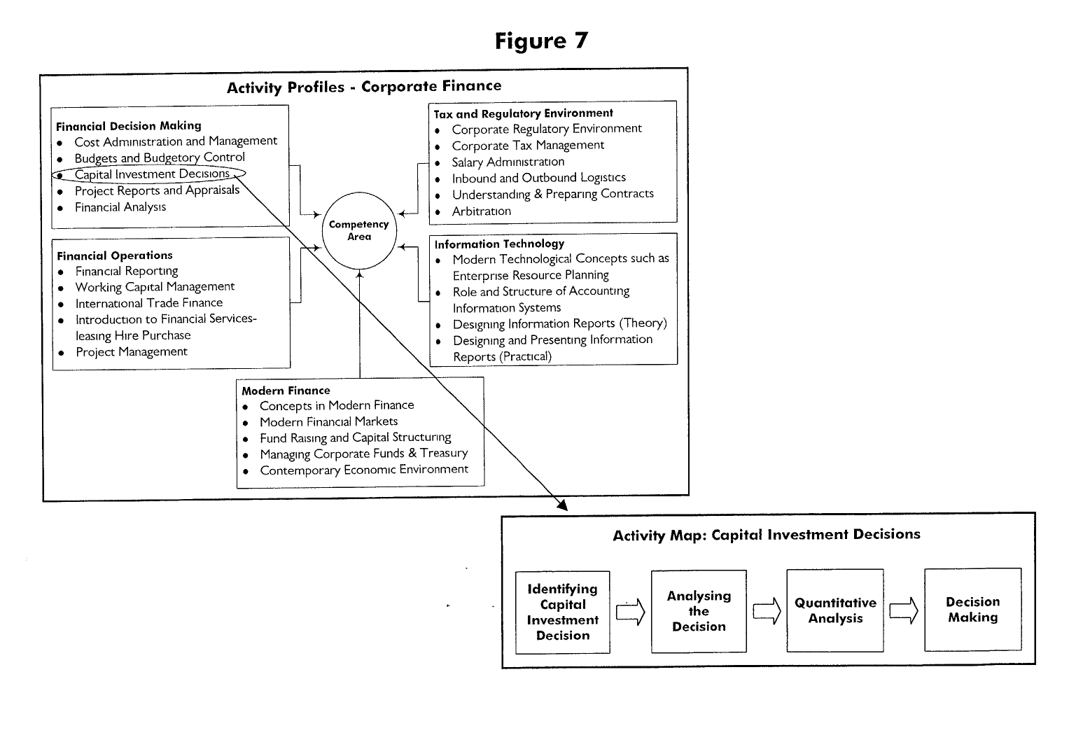

On being informed of the seeker context, the mapping engine then begins providing a specific cluster of maps that enable the corporate manager to quickly and accurately pull out or retrieve the needed knowledge or informational inputs from within the knowledge bases available to that manager. The mapping engine presents the series of maps relevant to the seeker context as a set of choice making situations. It is important to note that these maps are essentially defined in terms of numerous distinct work profiles associated with that function as described in FIG. 7.

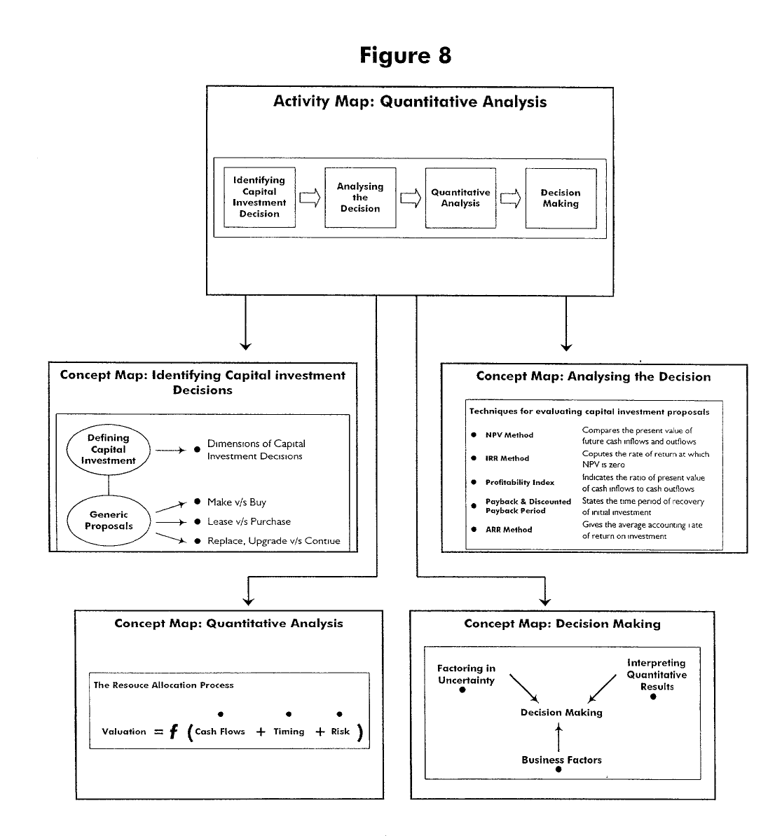

The activity work maps which present a simplified, but more useful view of that activity profile are described in FIG. 8.

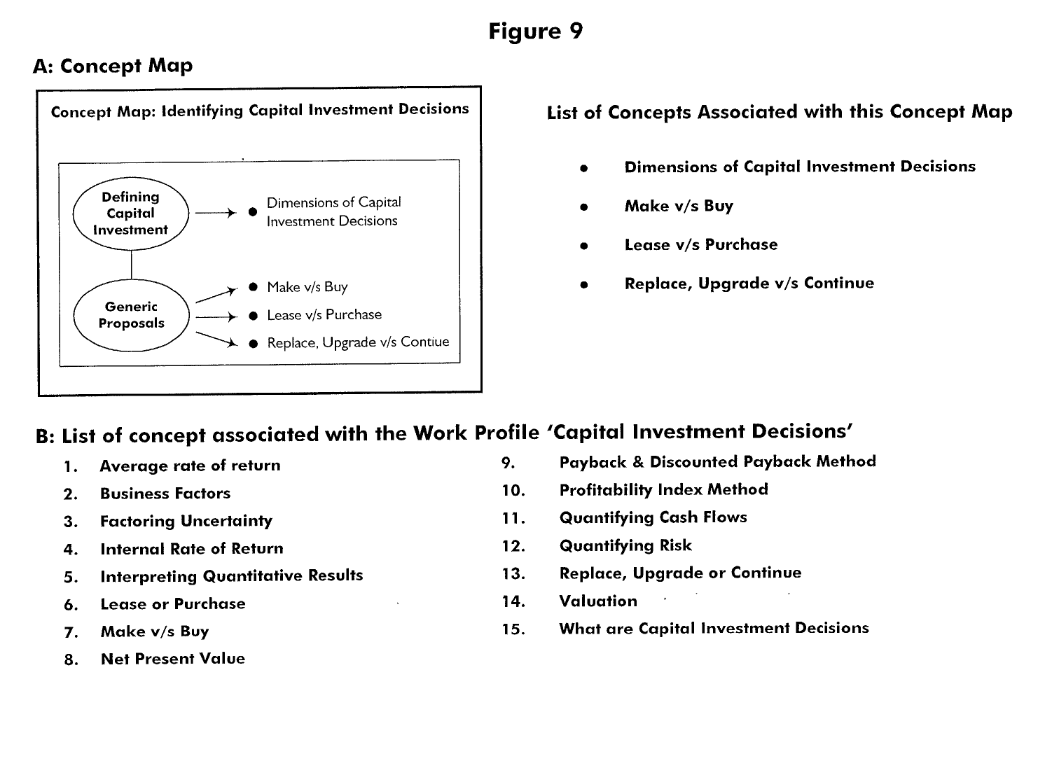

Concept maps which identify and present the set of concepts as relevant to that activity profile are described in FIG. 9.

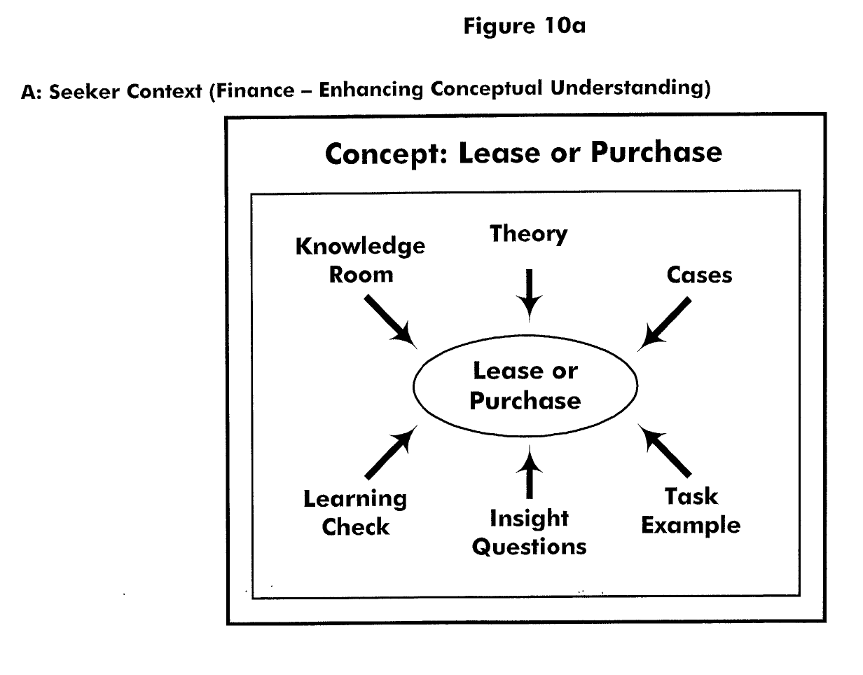

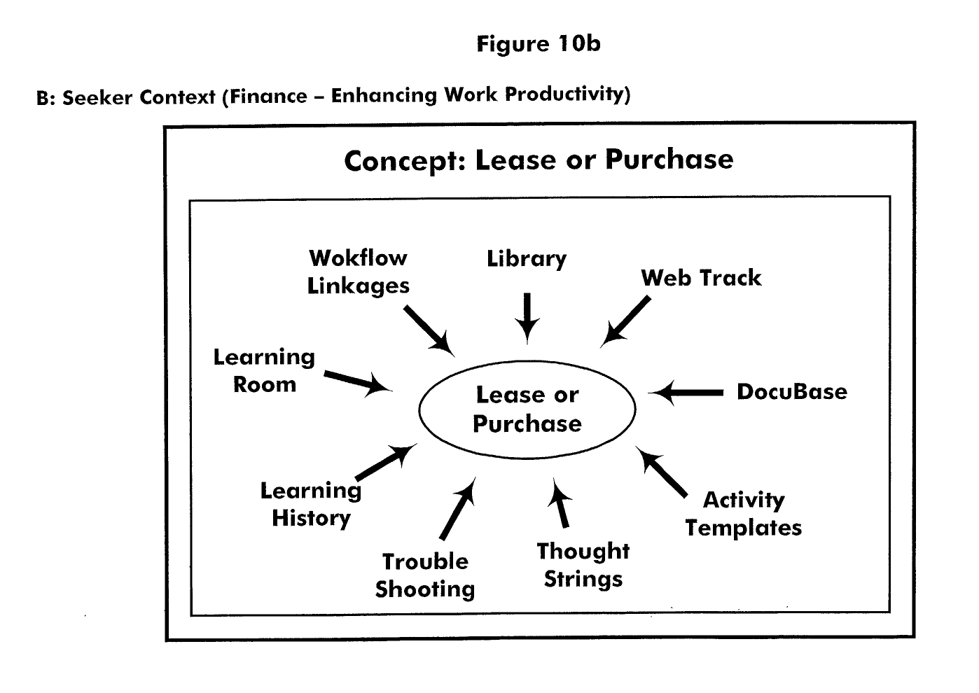

Concepts are identified on the basis of critical units of managerial work associated with that activity and may be viewed in terms of a specific managerial risk (e.g., writing a report) or making a decision (e.g., lease or buy equipment), as described in FIG. 10.

In all cases, the user finally arrives at a concept and a set of knowledge paths, if the user has chosen the context of learning then he or she arrives at a set of knowledge paths as shown in FIG. 10(A). If the user has chosen the context of work then he or she will arrive at a set of knowledge paths as shown in FIG. 10(B).

The user then chooses the knowledge path required. The mapping engine now generates a query from the databases for all documents meeting the characterization requirements as defined in, seeker, context, concept, knowledge path. (e.g., finance manager, learning, make or buy, theory.).

### Knowledge base of ESCOT

The knowledge base of ESCOT varies from one corporation to another depending upon the database designs and structures within the corporation. In all cases, the guiding principle is the conversion of the query from the mapping engine being translated into some form of structured or other query language as appropriate to the set of databases in that corporation or set of resources. Those skilled in the art know that the different database systems may use different programs or approaches (e.g., XML, Prolog, etc) with the same results and outcomes. Thus, ESCOT is built on new and logical paradigm of competency development. ESCOT can be developed for a specific organization or a specific function by: (a) identifying and mapping out the numerous work flows, (b) then for each work flow, identify current competency through concept testing, (c) providing work related knowledge through “multiple learning paths” which provide access to documentation and learning materials that enable a better understanding of the work at hand, (d) assessing intrinsic competency levels after background knowledge is acquired and (e) enabling the translation of knowledge into workplace performance by improving contextual competency levels through providing work related information and data resources around the same units of work.

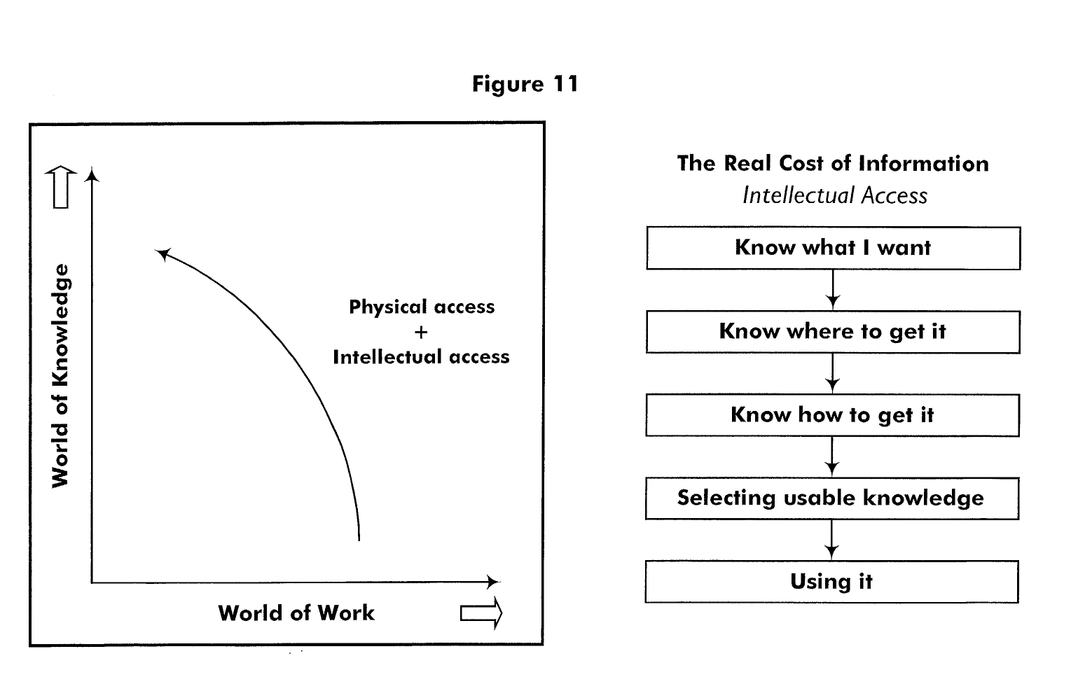

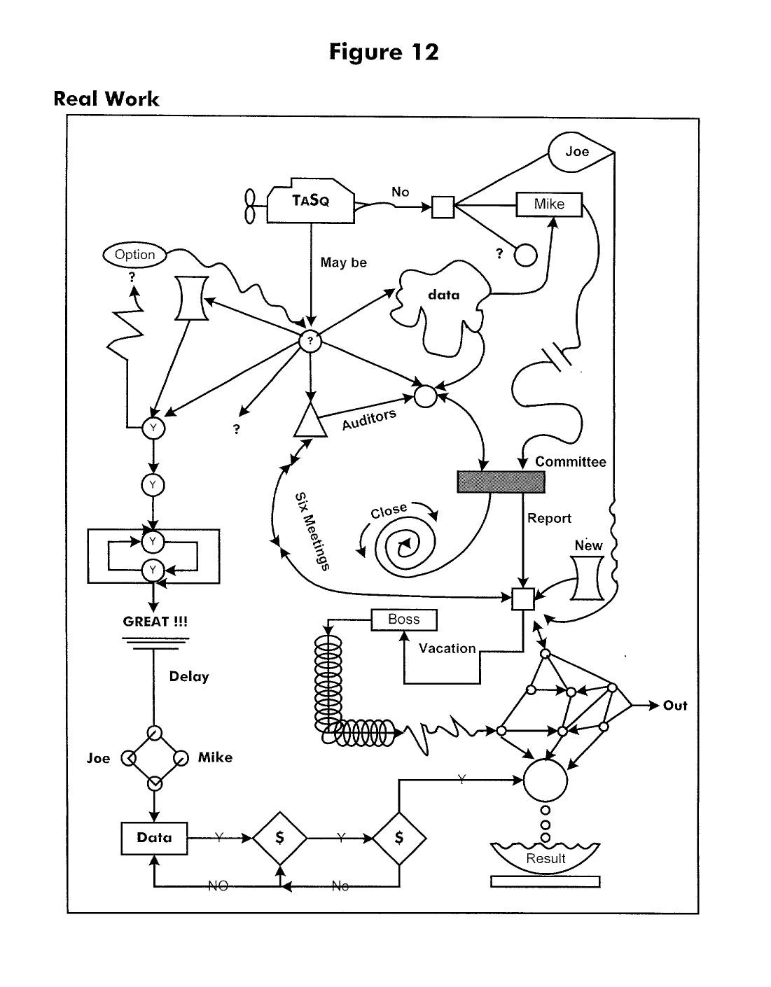

The real cost of information in action is prohibitive (FIG. 11) ESCOT enables better access to available knowledge (Table 2).

TABLE 2

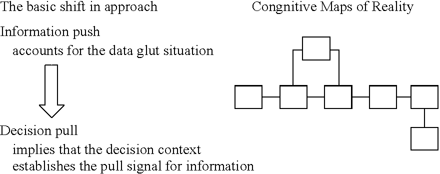

ESCOT makes knowledge more usable by combining navigational flexibility with hierarchical storage (Table 3).

TABLE 3

[chemical structure]

ESCOT allows integration of media and multiple learning paths to create powerful learning experiences (Table 4).

TABLE 4

[chemical structure]

For example, ESCOT can also be used to identify job applicants, corporate retraining, competency and skill gaps and needs of corporations in an organizational context. In fact, similar knowledge and access mechanisms can be used to significantly enhance utility of information in any system which has stored in it large amounts of information in the form of documentation, ideas, insights or concepts.

The present invention is not to be limited in scope by embodiments disclosed in the examples which are intended as an illustration of one aspect of the invention and any methods which are functionally equivalent are within the scope of the invention. Indeed, various modifications of the invention in addition to those shown and described herein will become apparent to those skilled in the art from the foregoing description. Such modifications are intended to fall within the scope of the appended claims.

Various publications are cited herein, the disclosures of which are incorporated by reference in their entireties.

What is claimed is:

1. A Concept Mapping based knowledge acquisition system loaded on a computer via a data input/output comprising:
a presentation layer which contextuslises the use of a database for a specific seeker of information and is related to a specific activity, decision context or situation;
a mapping engine which carries out primary task of linking up a seeker context to appropriate documents or results from said database, said database wherein said document or element are tagged accordingly to allow appropriate searches to be carried out.

2. The Concept Mapping based knowledge acquisition system according to claim 1, wherein the mapping engine comprises of clusters of interlinked maps, and said interlined maps linking the specific seeker context to an underlying structure of knowledge related to said seeker context.

3. The Concept Mapping based knowledge acquisition system according to claim 1, wherein said system enables a user to arrive at a concept page, said concept page comprising of a single concept and knowledge paths linked to said concept.

4. The Concept Mapping based knowledge acquisition system according to claim 3, wherein said system enables the user to select via a link or a pull-down menu, a knowledge path thereby triggering off a query of the database constructed on the dimensions comprising, seeker, context, concept, knowledge path., <seeker, context, concepts>, <seeker, concept>, <context, concept>, <concept, knowledgepath> or <concept>.

5. The Concept Mapping based knowledge acquisition system according to claim 4, further comprising of a knowledge base including one or more documents, said documents being characterized for different combinations of <seeker, context, concept, or knowledgepath>.

6. The Concept Mapping based knowledge acquisition system according to claim 5, wherein said system enables the identification of documents which meet the requirements of <seeker, context, concept or knowledgepath>, said requirements being generated by the mapping engine by using a querying and related computer system.

7. A Concept Mapping based knowledge acquisition system comprising:
a mapping engine,
said mapping engine comprising of clusters of interlinked maps, said maps linking a specific seeker context from a presentation layer to an underlying structure of knowledge related to said seeker concept, thereby enabling the mapping engine to be added to any computer system having a presentation layer and a queryable database.

8. A system of classification of knowledge wherein said system classifies any domain of knowledge in terms of concepts or knowledge paths, and said system uses said terms of classification to search or retrieve documentation from different mediums, wherein said mediums meet the addressing requirements including <seeker, context, concept, knowledgepath>, <seeker, context, concept>, <seeker, concept>, <context, concept>, <concept knowledgepath> or <concept>.

9. The system according to claim 8, wherein said system represents knowledge in groups of documents and ideas, said groups being clustered around and presented to a viewer in terms of multiple concepts and knowledgepaths.

10. The system according to claim 8, wherein said system comprises frameworks or maps as represented in any medium, thereby enabling a user to select a concept or knowledge path quickly and appropriately.

11. A system adapted for Competency Building, said system being used by corporate managers to continuously enhance and clarify various managerial tasks and decision making situations when needed.

12. A system adapted for Competency Building, said system being used by corporate managers to continuously enhance work performance by obtaining knowledge captured within an organization while said managers are performing a specific set of tasks.

13. A system adapted for Competency Building, said system enabling a corporate manager to accurately diagnose gaps in said corporate manager's conceptual understanding of the work profile.

14. The system according to claim 13, said system enabling a corporate manager to establish the benchmarked level of conceptual clarity needed to perform a set of tasks and decisions in a specific work profile.

15. The system according to claim 11, wherein said Competency Building system captures the need for continuous learning and access to corporate knowledge built around managerial activities.

16. The system according to claim 15, wherein said system comprises ESCOT.

17. The system according to claims 15 wherein, the Competency Building System defines a context.

18 The system according to claims 11, wherein the system comprises a Mapping Engine including several map clusters, said map clusters enabling the corporate to quickly and accurately retrieve needed knowledge from the knowledge base accessible to the manager.

19. The system according to claim 18, wherein said system includes a Mapping Engine including activity maps or concept maps.

20. The system according to claim 19,wherein said system enables the user to reach a concept or knowledge path, thereby enabling the user to generate a query from the databases for documents meeting the characteristics of <seeker, context, concept, knowledgepath>.

21. The system according to claim 20, wherein said system includes a knowledge base of documents from difference mediums, said documents being addressed in terms of <seeker, context, concept, knowledgepath>.

22. An Electronic Structure Competency Training (ESCOT) system comprising:
A plurality of taxonomies based on hierarchies or concepts,
Said concepts being variably determined by a knowledge user, and said concepts being based on the “need to know” sets of knowledge associated with work people do.

23. The ESCOT system according to claim 22, said system providing a process of competence building comprising:
diagnosing content,
accessing content,
learning content,
assessing content, and
using work related knowledge.

24. The ESCOT system according to claim 23, further comprising a process of concept strength analysis specific to each user and the user's role in a company.
